(19) United States
(12) Patent Application Publication
(10) Pub. No.: US 2026/0204172 A1
(43) Pub. Date: Jul. 16, 2026

(54) METHOD, MEDICAL TRAINING DEVICE, AND SYSTEM FOR GENERATING DYNAMIC VIRTUAL REPRESENTATIONS FOR MEDICAL TRAINING

(71) Applicant: SIMULATORY AG, Schlieren (CH)

(72) Inventors: Venkatraghavan Gourishankar, Schlieren (CH); Gayathri Trissur Venkatachalam, Schlieren (CH)

(73) Assignee: SIMULATORY AG, Schlieren (CH)

(21) Appl. No.: 19/138,092

(22) PCT Filed: Dec. 15, 2023
(86) PCT No.: PCT/IB2023/062766

§ 371 Date: Jun. 11, 2025

(30) Foreign Application Priority Data
Dec. 16, 2022 (IN) 202241073107

(51) Int. Cl. G09B 9/00

(52) U.S. Cl. CPC G09B 9/00

(57) ABSTRACT

The present disclosure relates to method, medical training device, and system for generating dynamic virtual representations for medical training. The method comprises receiving request for undertaking medical training on medical procedure and user skill information, from user (112); and providing dynamic virtual representation from dynamic virtual representations (108) corresponding to medical procedure, based on request and user skill information. The plurality of dynamic virtual representations (108) is generated for each of plurality of medical procedures using neural network model (106) by obtaining real-time patient data comprising imaging data and surgical data from one or more sources (102). Three-dimensional (3D) virtual representations are generated by mapping imaging data and surgical data using neural network model (106). A plurality of dynamic virtual representations (108) is generated by simulating haptic properties corresponding to 3D virtual representations. The user (112) receives haptic feedback while undertaking medical training based on simulated haptic properties.

### TECHNICAL FIELD

The present disclosure generally relates to medical training systems. More particularly, the present disclosure relates a method, a medical training device, and a system for generating dynamic virtual representations for medical training.

### BACKGROUND

Generally, traditional methods are followed for training in medical field. One such traditional method is a SODOTO methodology of see one, do one and teach one, where a user needs to see a medical procedure being performed on a real patient, perform the medical procedure on the real patient, and thereafter teach the medical procedure. The SODOTO methodology has been supplemented by a series of two-dimensional (2D) static medical imaging data and cadaver dissection. The 2D static medical imaging data comprises images of tests such as X-ray, Computed Tomography (CT), Magnetic Resonance Imaging (MRI), Positron Emission Tomography (PET), Ultrasound, and the like. Additionally, anatomical models of diverse types, such as plastic organs, are used to supplement human models for training in the medical field.

However, static images from 2D medical imaging data used in the SODOTO methodology data do not convey necessary information for understanding a patient's case and preparing for necessary medical intervention. Notably, such methodology does not provide useful assistance to users/healthcare professionals seeking practical instruction through hands-on trials on complicated unfamiliar procedures. Such inadequate information and training leads to errors committed by the users.

Conventional systems for providing medical training to the users teach virtual training scenarios that are modelled manually based on generic human anatomy data. However, such systems fail to incorporate variance in physiology between different patient cases. Hence, such systems can provide only a limited number of scenarios restricted to the generic human anatomy data. Also, such systems do not consider the skill level of users to generate the virtual training scenarios.

The information disclosed in this background of the disclosure section is only for enhancement of understanding of the general background of the invention and should not be taken as an acknowledgement or any form of suggestion that this information forms the prior art already known to a person skilled in the art.

### SUMMARY

In an embodiment, the present disclosure discloses a method of generating dynamic virtual representations for medical training. The method comprises receiving a request for undertaking a medical training on a medical procedure and user skill information, from a user. Further, the method comprises providing a dynamic virtual representation from a plurality of dynamic virtual representations corresponding to the medical procedure, based on the request and the user skill information. The medical training device generates the plurality of dynamic virtual representations for each of a plurality of medical procedures using a neural network model. The plurality of dynamic virtual representations is generated by obtaining real-time patient data corresponding to a plurality of patients. The real-time patient data comprises imaging data and surgical data for each of the plurality of medical procedures, from one or more sources. A plurality of three-dimensional (3D) virtual representations are generated for each of the plurality of medical procedures, by mapping the corresponding imaging data and the surgical data using the neural network model. The plurality of dynamic virtual representations is generated for each of the plurality of medical procedures, by simulating one or more haptic properties corresponding to the plurality of 3D virtual representations. The user receives haptic feedback while undertaking the medical training based on the one or more simulated haptic properties.

In an embodiment, the present disclosure discloses a medical training device for generating dynamic virtual representations for medical training. The medical training device comprises a processor and a memory. The processor is configured to receive a request for undertaking a medical training on a medical procedure and user skill information, from a user. Further, the processor is configured to provide a dynamic virtual representation from a plurality of dynamic virtual representations corresponding to the medical procedure, based on the request and the user skill information. The processor generates the plurality of dynamic virtual representations for each of a plurality of medical procedures using a neural network model. The processor generates the plurality of dynamic virtual representations by obtaining real-time patient data corresponding to a plurality of patients. The real-time patient data comprises imaging data and surgical data for each of the plurality of medical procedures, from one or more sources. A plurality of three-dimensional (3D) virtual representations are generated for each of the plurality of medical procedures, by mapping the corresponding imaging data and the surgical data using the neural network model. The plurality of dynamic virtual representations is generated for each of the plurality of medical procedures, by simulating one or more haptic properties corresponding to the plurality of 3D virtual representations. The user receives haptic feedback while undertaking the medical training based on the one or more simulated haptic properties.

In an embodiment, the present disclosure discloses a system for generating dynamic virtual representations for medical training. The system comprises a haptic device and a medical training device. The medical training device receives a request for undertaking a medical training on a medical procedure and user skill information, from a user. Further, the medical training device is configured to provide a dynamic virtual representation from a plurality of dynamic virtual representations corresponding to the medical procedure, based on the request and the user skill information. The medical training device generates the plurality of dynamic virtual representations for each of a plurality of medical procedures using a neural network model. The medical training device generates the plurality of dynamic virtual representations by obtaining real-time patient data corresponding to a plurality of patients. The real-time patient data comprises imaging data and surgical data for each of the plurality of medical procedures, from one or more sources. A plurality of three-dimensional (3D) virtual representations are generated for each of the plurality of medical procedures, by mapping the corresponding imaging data and the surgical data using the neural network model. The plurality of dynamic virtual representations is generated for each of the plurality of medical procedures, by simulating one or more haptic properties corresponding to the plurality of 3D virtual representations. The user receives haptic feedback while undertaking the medical training based on the one or more simulated haptic properties.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The novel features and characteristics of the disclosure are set forth in the appended claims. The disclosure itself, however, as well as a preferred mode of use, further objectives, and advantages thereof, will best be understood by reference to the following detailed description of an illustrative embodiment when read in conjunction with the accompanying figures. One or more embodiments are now described, by way of example only, with reference to the accompanying figures wherein like reference numerals represent like elements and in which:

FIG. 1A illustrates an exemplary environment for generating dynamic virtual representations for medical training, in accordance with some embodiments of the present disclosure;

FIG. 1B illustrates an exemplary system for generating dynamic virtual representations for medical training, in accordance with some embodiments of the present disclosure;

FIG. 2 illustrates a detailed diagram of a medical training device for generating the dynamic virtual representations for medical training, in accordance with some embodiments of the present disclosure;

FIGS. 3A and 3B show exemplary illustrations for generating the dynamic virtual representations for medical training, in accordance with some embodiments of the present disclosure;

FIGS. 4A and 4B show exemplary flow charts illustrating method steps for generating the dynamic virtual representations for medical training, in accordance with some embodiments of the present disclosure;

FIG. 5 shows a block diagram of a general-purpose computing system for generating the dynamic virtual representations for medical training, in accordance with embodiments of the present disclosure.

It should be appreciated by those skilled in the art that any block diagram herein represents conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternatives falling within the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

The present disclosure relates to generating dynamic virtual representations for medical training. In the present disclosure, a neural network model is trained with real-time patient data including surgical data and imaging data of patients. The neural network model generates various three-dimensional (3D) virtual representations using the real-time patient data. Hence, the present disclosure incorporates variance in physiology between different patient cases for generating the 3D virtual representations. The 3D virtual representations can be provided to a user for undergoing medical training This results in generation of unique patient scenarios for medical training of the user.

The present disclosure generates various dynamic virtual representations corresponding to the 3D virtual representations by simulating haptic properties. This allows the user to receive real-time haptic feedback while undergoing the medical training. Hence, the present disclosure provides unique dynamic and interactive patient scenarios for medical training of the user.

The present disclosure considers a skill level of a user when providing the dynamic virtual representation for medical training. Hence, a difficulty level of training scenario is automatically adjusted according to the skill level of the user, thus improvising learning experience of the user.

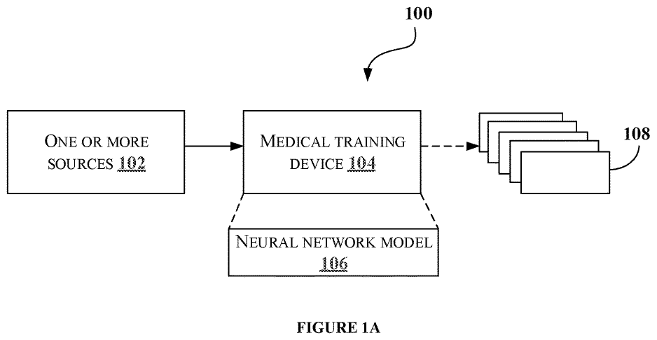

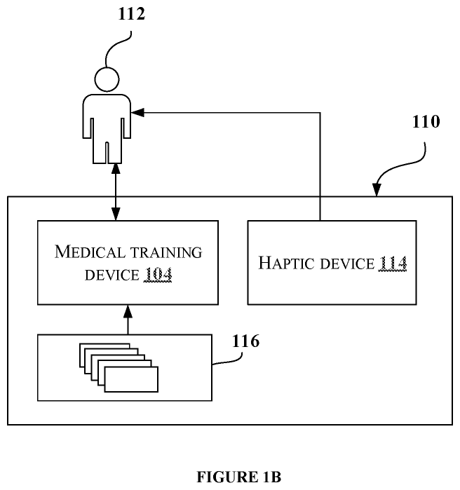

FIG. 1A illustrates an exemplary environment 100 for generating dynamic virtual representations for medical training, in accordance with the embodiments of the present disclosure. The exemplary environment 100 comprises one or more sources 102, a medical training device 104, and a neural network model 106. The present disclosure relates to providing medical training to a user (not shown in FIG. 1A). The medical training of the user refers to training the user on a medical procedure or various medical procedures. Such medical procedures may include, but are not limited to, spine surgery, knee replacement surgery, bone marrow transplant, and the like. In the present disclosure, the medical training device 104 is used to generate the dynamic virtual representations 108 for medical training of the user. The medical training device 104 may be implemented in any computing device, such as, but not limited to, a personal computer, a desktop, a tablet, a mobile phone, a smartphone, and the like.

The medical training device 104 generates a plurality of dynamic virtual representations 108 using the neural network model 106. The neural network model 106 which is also known as an artificial neural network, is a computing system with interconnected nodes. The neural network model 106 recognizes hidden patterns and correlations in data, clusters and classifies them over time for continuous learning and improvement. In an embodiment, the neural network model 106 may be a Generative Adversarial Network (GAN) to generate the dynamic virtual representations 108. A person skilled in the art will appreciate that the present disclosure is applicable to any neural networks other than the above-mentioned neural networks, such as, but not limited to, a Convolution Neural Network (CNN), a Recurrent Neural Network (RNN), a Long Short-term Memory (LSTM), a recursive neural network, a graph convolutional network, a sequential neural network, an encoder-decoder network, and a combination thereof.

In an embodiment, the medical training device 104 is configured to generate the plurality of dynamic virtual representations 108 for medical training, using the neural network model 106. Herein, the medical training device 104 obtains real-time patient data corresponding to multiple patients for each of a plurality of medical procedures, from the one or more sources 102. In an example, the one or more sources 102 may include a database comprising real-time patient data of twenty patients with varying medical conditions. The real-time patient data includes imaging data and surgical data for each of the plurality of medical procedures. The imaging data may include, for instance, images of X-Ray test of the patients. The surgical data may include, for instance, video data of a surgeon performing a knee replacement surgery. The medical training device 104 maps the imaging data and the surgical data corresponding to each medical procedure, using the neural network model (106), to generate three-dimensional (3D) virtual representations. For instance, the medical training device 104 may generate a 3D virtual representation illustrating a human anatomy, the images of X-Ray test of a patient, tools used for surgery, and guidance texts corresponding to the knee replacement surgery.

Further, the medical training device 104 generates the plurality of dynamic virtual representations 108 for each medical procedure, by simulating one or more haptic properties corresponding to the 3D virtual representations. Herein, the medical training device 104 assigns the haptic properties of tools associated with the corresponding medical procedure and anatomy of the patients, to the 3D virtual representations.

FIG. 1B illustrates an exemplary system 110 for generating the plurality of dynamic virtual representations 108 for medical training, in accordance with embodiments of the present disclosure. The system 110 comprises the medical training device 104 and a haptic device 114. The medical training device 104 receives a request for undertaking a medical training on a medical procedure and user skill information, from a user 112. A database 116 associated with the system 110 may store the plurality of dynamic virtual representations 108 associated with a plurality of medical procedures generated using the neural network model 106. The medical training device 104 obtains the plurality of dynamic virtual representations 108 corresponding to the medical procedure, from the database 116. Then, the medical training device 104 provides a dynamic virtual representation from the dynamic virtual representations 108 based on the user skill information. For instance, when the user 112 is in a beginner stage, a dynamic virtual representation corresponding to a minor surgery is provided to the user 112. The haptic device 114 is a motorized device that applies force feedback on users' hand, allowing to experience the plurality of dynamic virtual representations 108 and producing sensations while the user 112 is undertaking training using the plurality of dynamic virtual representations 108. The haptic device 114 provides haptic feedback during the medical training based on the one or more simulated haptic properties.

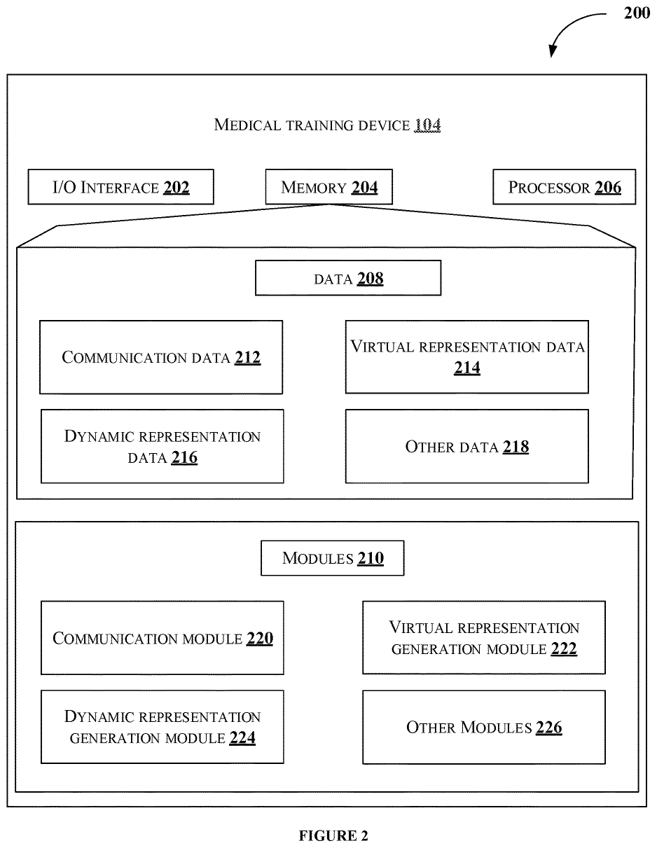

FIG. 2 illustrates a detailed diagram 200 of the medical training device 104 for generating the dynamic virtual representations 108 for medical training, in accordance with some embodiments of the present disclosure. The medical training device 104 may include Central Processing Units 206 (also referred as “CPUs” or “a processor 206”), Input/Output (I/O) interface 202, and a memory 204. In some embodiments, the memory 204 may be communicatively coupled to the processor 206. The memory 204 stores instructions executable by the processor 206. The processor 206 may comprise at least one data processor for executing program components for executing user or system-generated requests. The memory 204 may be communicatively coupled to the processor 206. The memory 204 stores instructions, executable by the processor 206, which, on execution, may cause the processor 206 to generate the dynamic virtual representations 108 for medical training. In an embodiment, the memory 204 may include one or more modules 210 and data 208. The one or more modules 210 may be configured to perform the steps of the present disclosure using the data 208. In an embodiment, each of the one or more modules 210 may be a hardware unit which may be outside the memory 204 and coupled with the medical training device 104. As used herein, the term modules 210 refers to an Application Specific Integrated Circuit (ASIC), an electronic circuit, a Field-Programmable Gate Arrays (FPGA), Programmable System-on-Chip (PSoC), a combinational logic circuit, and/or other suitable components that provide described functionality. The one or more modules 210 when configured with the described functionality defined in the present disclosure will result in a novel hardware. Further, the I/O interface 202 is coupled with the processor 206 through which an input signal or/and an output signal is communicated. For instance, the medical training device 104 may receive the request for undergoing the medical training from the user 112, via the I/O interface 202. In an embodiment, the medical training device 104 may be implemented on a physical computing system. In another embodiment, the medical training device 104 may be implemented on a quantum computing hardware not only restricted to physical computing systems but also to electrical components like memristors and other quantum computing-able systems which can process and analyze Qubits.

In one implementation, the modules 210 may include, for example, a communication module 220, a virtual representation generation module 222, a dynamic representation generation module 224, and other modules 226. It will be appreciated that such aforementioned modules 210 may be represented as a single module or a combination of different modules. In one implementation, the data 208 may include, for example, communication data 212, virtual representation data 214, dynamic representation data 216, and other data 218.

In an embodiment, the communication module 220 may be configured to obtain real-time patient data corresponding to the plurality of patients, for each of the plurality of medical procedures. The real-time patient data comprises imaging data and surgical data. The imaging data may comprise two-dimensional (2D) patient data. For instance, the imaging data may comprise images of results from tests such as X-Ray, Magnetic Resonance Imaging (MRI), Computed Tomography (CT), Ultrasound, and the like. The surgical data may comprise real-time surgery videos, continuous measurement of patient vitals like blood pressure, respiratory rate, heart rate, body temperature, and the like. The surgical data may comprise, but is not limited to, camera visuals, tools visuals, vital monitoring equipment visuals. The surgical data may include an accurate visual representation of patient anatomy during a medical procedure as observed by the medical professional in an operating room. For example, the surgical data may include an accurate visual representation from the perspective of medical professional.

The communication module 220 may receive the real-time patient data from the one or more sources 102. In an example, the one or more sources 102 may include a curated patient case database. The patient case database may include the real-time patient data of the plurality of patients sorted based on a medical procedure type, patient background information, risk level of a patient, and/or based on pre-existing conditions. Examples of the pre-existing conditions include, but are not limited to, blood group, bleeding criteria, diabetes, anatomy deformities, reoperation criteria, anesthetic risk, and age. In an example, the one or more sources 102 may include one or more capturing units in an operation room. For instance, surgery videos may be received as camera feed from surgical instruments like endoscopic cameras, operating microscopes, and other cameras that are present in the operating room to record a medical procedure. In an example, the patient case database may include the real-time patient data of five patients corresponding to each medical procedure. The medical procedure may be spine surgery. The imaging data may comprise X-Ray images of the patients. The surgical data may comprise videos of surgeon(s) performing spine surgery on the patients. The real-time patient data may be stored as the communication data 212 in the memory 204.

In an embodiment, the virtual representation generation module 222 may be configured to receive the communication data 212 from the communication module 220. Further, the virtual representation generation module 222 may be configured to generate a plurality of three-dimensional (3D) virtual representations for each of the plurality of medical procedures using the neural network model 106. The virtual representation generation module 222 may generate the plurality of 3D virtual representations by mapping the imaging data and the surgical data. Herein, the virtual representation generation module 222 may identify a plurality of medical conditions associated with the plurality of patients, based on the imaging data, using the neural network model 106. The neural network model 106 may reconstruct patient anatomy using the imaging data. The neural network model 106 may identify the plurality of medical conditions using classification. The neural network model 106 may perform the classification using techniques such as Logistic Regression, Naive Bayes, K-nearest Neighbors, and the like.

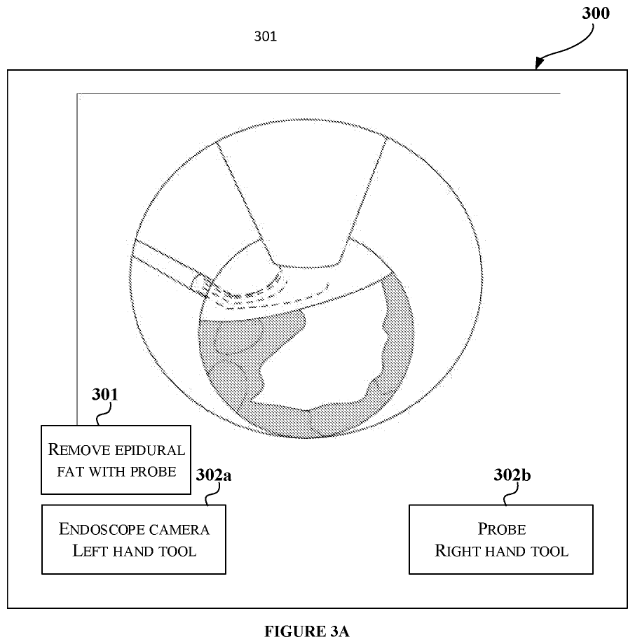

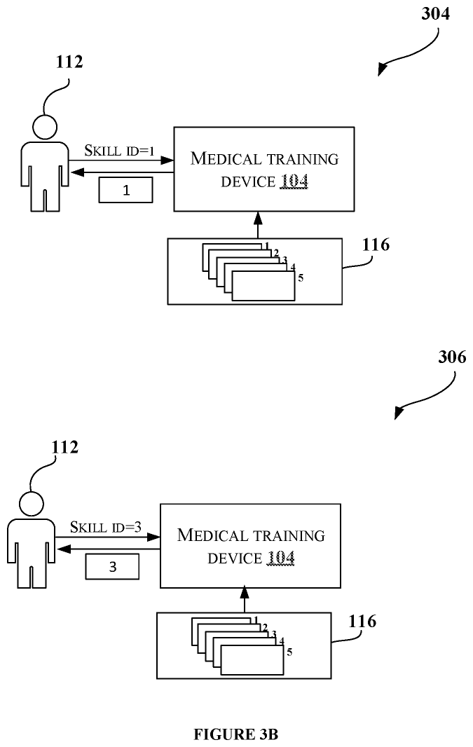

Further, the virtual representation generation module 222 may identify an anatomy of each of the plurality of patients, tools associated with a surgery, a sequence of usage of the tools, for each of the plurality of medical procedures, based on the surgical data, using the neural network model 106. The neural network model 106 may identify the anatomy and may classify the anatomy based on visual representation. Further, the neural network model 106 may perform identification of tools used in a surgery and the sequence/paths of the tools followed by a medical practitioner during a medical procedure. In an example, the virtual representation generation module 222 may identify different bones and ligaments associated with the spine surgery, the tools used to perform the spine surgery, and the sequence of tools used by the medical practitioner when performing the spine surgery. The virtual representation generation module 222 may generate the plurality of 3D virtual representations, based on the identification. The plurality of 3D virtual representations may include a static 3D reconstruction of the patient data with representation of the underlying patient condition. FIG. 3A illustrates an exemplary 3D virtual representation 300 associated with spine surgery. As shown, the exemplary 3D virtual representation 300 illustrates the anatomy of a patient, the tools 302a and 302b used in the medical procedure, texts 301 for guiding the user such as “remove epidural fat with probe”, and the like. In an embodiment, robotic arms may be provided to the user 112 during the medical training. The robotic arms may be used to control objects on the plurality of 3D virtual representations. Further, control mechanisms such as a pedal may be provided for controlling tools or changing tools during the medical training.

Referring back to FIG. 2, in an embodiment, the neural network model 106 may be a Generative Adversarial Network (GAN). The GAN may be trained using basic anatomy of patient cases. Additionally, the real-time patient data may be provided to the GAN to generate unique 3D virtual representations via repetitive supervised learning. The GAN may be trained rigorously over numerous iterations with real data based on generator/discriminator model of the GAN. Such a generative learning process is beneficial in medical training as it saves time and resources for repeatedly creating generic patient data or manually inputting different patient data while generating the unique 3D virtual representations. In another embodiment, the neural network model 106 may be implemented on Quantum machine learning platforms though conversion of data to Quantum bits or Qubits that considerably speeds up computing process and allows for faster discriminator comparison and thereby faster and accurate data predictions. A person skilled in the art will appreciate that any neural network model other than the above-mentioned neural network models may be used to generate the plurality of 3D virtual representations. The plurality of 3D virtual representations may be stored as the virtual representation data 214 in the memory 204.

In an embodiment, the dynamic representation generation module 224 may be configured to receive the virtual representation data 214 from the virtual representation generation module 222. Further, the dynamic representation generation module 224 may be configured to generate the plurality of dynamic virtual representations 108 for each of the plurality of medical procedures. The dynamic representation generation module 224 may simulate one or more haptic properties corresponding to the plurality of 3D virtual representations, to generate the plurality of dynamic virtual representations 108. The one or more haptic properties may comprise at least one of, material surface properties and physical properties. The physical properties corresponding to the plurality of 3D virtual representations may include weight, hardness, viscosity, density, tension etc. For example, the physical properties may include weight of surgical tools, hardness of bone, viscosity of blood, density of tightly packed fat, tension of muscles, etc. The material surface properties may include surface hardness or softness, surface roughness or smoothness, surface textures/patterns, etc.

The dynamic representation generation module 224 may identify the one or more haptic properties of tools associated with the medical procedure and anatomy of the plurality of patients, based on the imaging data and the surgical data. For instance, the medical procedure may be spine surgery. The one or more haptic properties of tools associated with spine surgery may include weight of surgical tools used in the spine surgery. The one or more haptic properties of anatomy of the plurality of patients associated with the spine surgery may include hardness of bones, tension of muscles, etc. The dynamic representation generation module 224 may generate a force value for each of the one or more haptic properties corresponding to the tools and the anatomy. Herein, the dynamic representation generation module 224 may generate a force vector comprising force values of the one or more haptic properties. The force vector may then be converted into a torque. The torque may be applied on motors on the haptic device 114 to simulate the one or more haptic properties. The haptic device 114 is an electro-mechanical interface that transfers a three-dimensional force to the hand of the user 112. The force vector may be applied to the user's hands through electro-mechanical interface of the haptic device like motors, brakes, pumps, and the like.

In an example, consider simulation of a user/surgeon holding a scalpel and trying to make an incision on the back of a patient. The weight of the scalpel is a physical property that is simulated using equation of F=mg, where ‘m’ is described as the mass of the scalpel and ‘g’ is the acceleration due to gravity (vector). ‘F’ is generated as a force vector that signifies the forces in X, Y and Z directions (cartesian coordinates). The force vector is sent to a haptic interface by converting into torque using a Jacobian matrix. The Jacobian matrix allows conversion of parameters from joint space to the cartesian space and vice versa, using below-mentioned equation (1)

$$Torque = Transpose ( Jacobian ) \times F \qquad ( 1 )$$

The torque is then applied to the motors of the haptic device 114 to simulate the one or more haptic properties. A series of torques are generated from a series of forces generated at a rate of one force/torque vector per milli second or less. Similarly, forces encountered during cutting, drilling, pushing grabbing, punching using different tools like scalpel, rongeur, punch, drills, electro-probe etc. may be measured appropriately using force sensors and the torque may be applied to the haptic device 114. The physical properties may be quantified from real objects using common standardized test for each property. For example, the Brinell test may be used for determining the hardness of real objects. Weight of objects may be measured on a weighing scale. Also, the physical properties for known objects and materials may be directly obtained from standardized numbers catalogue. Referring to FIG. 3A, the user 112 may be guided to remove the epidural fat with probe. The weight of the probe may be applied on the motors of the haptic device 114, when the user 112 is undertaking the medical training. Also, when the user 112 does not remove the epidural fat entirely, a sensation may be provided as haptic feedback using the haptic device 114. Referring back to FIG. 2, the plurality of dynamic virtual representations 108 may be stored as the dynamic representation data 216 in the memory 204.

In an embodiment, the communication module 220 may be further configured to receive a request for undertaking the medical training on the medical procedure and user skill information, from the user 112. The user skill information may comprise a user skill identification (ID) which is a unique tag assigned to every user based on skill level of the user 112. For example, the user skill ID may range from 1 to 5, where 1 corresponds to a low skill level (beginner) and 5 corresponds to a high skill level (expert) and other skill levels in between accordingly. In an example, the user skill ID for a user may vary based on a medical procedure. For example, a user may have a user skill ID of 5 for heart procedures but may have a skill ID of 2 for brain surgery. The request and the user skill information may be stored as the communication data 212 in the memory 204.

The communication module 220 may be configured to provide a dynamic virtual representation from the plurality of dynamic virtual representations 108 corresponding to the medical procedure, based on the request and the user skill information. Herein, the communication module 220 may identify a skill level associated with the user 112 based on the user skill information. The communication module 220 may map the skill level of the user 112 with a risk level associated with each of the plurality of dynamic virtual representations 108 based on predefined mapping information. The communication module 220 may provide the dynamic virtual representation based on the mapping. In an example, the patient case database may comprise patient anatomy for various patient cases, patient background information and a unique risk ID assigned to every case based on risk classification of the patient. For example, a risk ID may range from 1 to 5, where 1 corresponds to a low risk level for a medical procedure to 5 corresponding to a high-risk level. The user skill ID may be mapped to the risk ID for selecting the dynamic virtual representation.

Referring to example 304 illustrated in FIG. 3B, a user with skill ID=1 which corresponds to low skilled user is matched with a dynamic virtual representation with risk ID=1 which corresponds to low-risk patient and thereby an easy case for training is selected. In an embodiment, the progress of the user 112 in the medical training is tracked through a performance score and the user skill ID of the user 112 is updated and adjusted accordingly. Referring to example 306 illustrated in FIG. 3B, the user skill ID is updated to 3, upon undertaking the medical training over a period of time.

The other data 218 may store data, including temporary data and temporary files, generated by the one or more modules 210 for performing the various functions of the medical training device 104. The one or more modules 210 may also include the other modules 226 to perform various miscellaneous functionalities of the medical training device 104. The other data 218 may be stored in the memory 204. It will be appreciated that the one or more modules 210 may be represented as a single module or a combination of different modules.

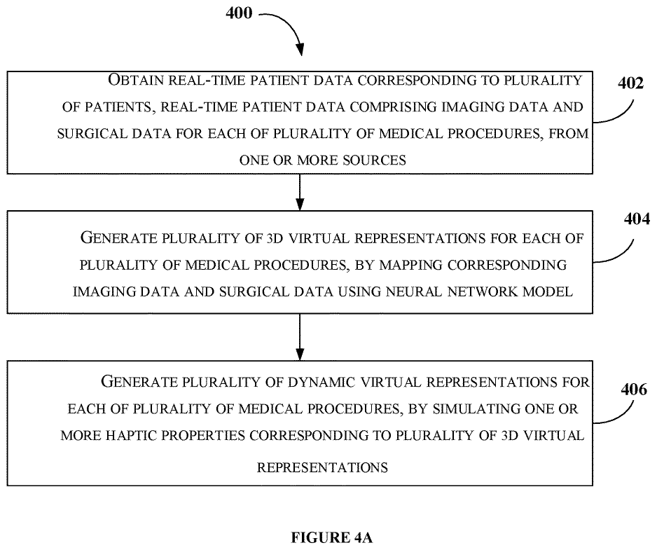

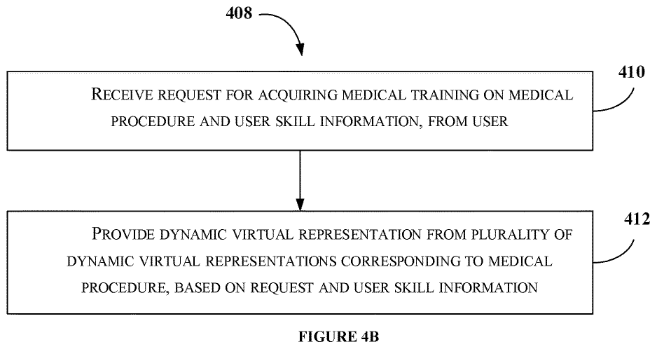

FIG. 4 shows an exemplary flow chart illustrating method steps for generating the dynamic virtual representations for medical training, in accordance with some embodiments of the present disclosure. As illustrated in FIG. 4, the method 400 may comprise one or more steps. The method 400 may be described in the general context of computer executable instructions. Generally, computer executable instructions can include routines, programs, objects, components, data structures, procedures, modules, and functions, which perform particular functions or implement particular abstract data types.

The order in which the method 400 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At step 402, the real-time patient data corresponding to the plurality of patients may be obtained for each of the plurality of medical procedures, from the one or more sources 102. The real-time patient data comprises imaging data and surgical data. The imaging data may comprise two-dimensional (2D) patient data. The surgical data may comprise real-time surgery videos, continuous measurement of patient vitals like blood pressure, respiratory rate, heart rate, body temperature, and the like.

At step 404, the plurality of 3D virtual representations may be generated for each of the plurality of medical procedures using the neural network model 106. The plurality of 3D virtual representations may be generated by mapping the imaging data and the surgical data.

At step 406, the plurality of dynamic virtual representations 108 may be generated for each of the plurality of medical procedures. The one or more haptic properties corresponding to the plurality of 3D virtual representations may be simulated, to generate the plurality of dynamic virtual representations 108. The one or more haptic properties may comprise at least one of, material surface properties and physical properties.

FIG. 4B shows an exemplary flow chart illustrating method steps for providing the dynamic virtual representation to the user 112, in accordance with some embodiments of the present disclosure. As illustrated in FIG. 4B, the method 408 may comprise one or more steps. The method 408 may be described in the general context of computer executable instructions. Generally, computer executable instructions can include routines, programs, objects, components, data structures, procedures, modules, and functions, which perform particular functions or implement particular abstract data types.

The order in which the method 408 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At step 410, a request for undertaking the medical training on the medical procedure and user skill information may be received from the user 112. The user skill information may comprise a user skill identification (ID) which is a unique tag assigned to every user based on skill level of the user 112.

At step 412, a dynamic virtual representation may be provided from the plurality of dynamic virtual representations 108 corresponding to the medical procedure, based on the request and the user skill information.

### Computer System

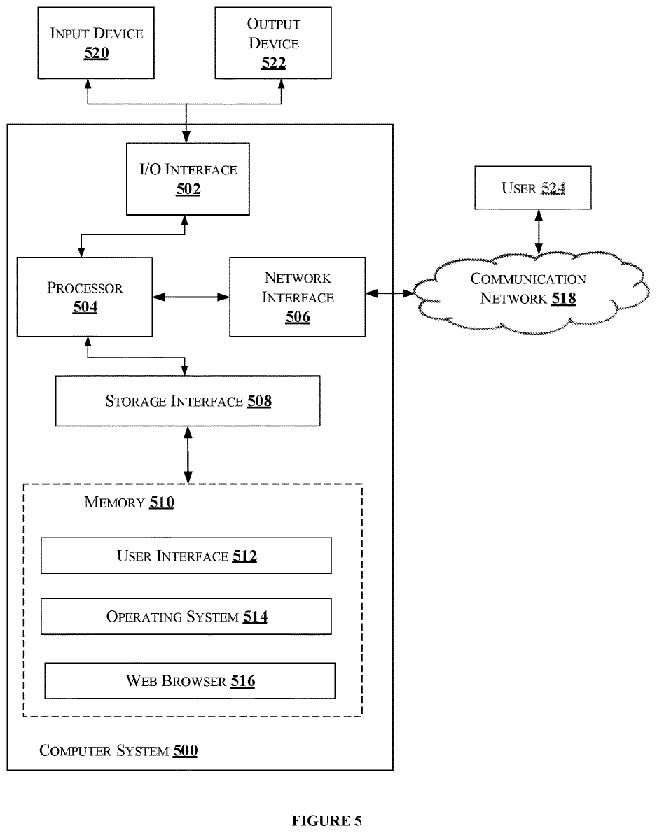

FIG. 5 illustrates a block diagram of an exemplary computer system 500 for implementing embodiments consistent with the present disclosure. In an embodiment, the computer system 500 may be the medical training device 104. Thus, the computer system 500 may be used to generate the dynamic virtual representations for medical training. The computer system 500 may communicate with the user 524, over a communication network 518. The computer system 500 may comprise a Central Processing Unit 504 (also referred as “CPU” or “processor”). The processor 504 may comprise at least one data processor. The processor 504 may include specialized processing units such as integrated system (bus) controllers, memory management control units, floating point units, graphics processing units, digital signal processing units, etc.

The processor 504 may be disposed in communication with one or more input/output (I/O) devices (not shown) via I/O interface 502. The I/O interface 502 may employ communication protocols/methods such as, without limitation, audio, analog, digital, monoaural, RCA, stereo, IEEE (Institute of Electrical and Electronics Engineers)-1394, serial bus, universal serial bus (USB), infrared, PS/2, BNC, coaxial, component, composite, digital visual interface (DVI), high-definition multimedia interface (HDMI), Radio Frequency (RF) antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 502, the computer system 500 may communicate with one or more I/O devices. For example, the input device 520 may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output device 522 may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

The processor 504 may be disposed in communication with the communication network 518 via a network interface 505. The network interface 505 may communicate with the communication network 518. The network interface 505 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 518 may include, without limitation, a direct interconnection, local area network (LAN), wide area network (WAN), wireless network (e.g., using Wireless Application Protocol), the Internet, etc. The network interface 505 may employ connection protocols include, but not limited to, direct connect, Ethernet (e.g., twisted pair 10/100/1000 Base T), transmission control protocol/internet protocol (TCP/IP), token ring, IEEE 802.11a/b/g/n/x, etc.

The communication network 518 includes, but is not limited to, a direct interconnection, an e-commerce network, a peer to peer (P2P) network, local area network (LAN), wide area network (WAN), wireless network (e.g., using Wireless Application Protocol), the Internet, Wi-Fi, and such. The first network and the second network may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the first network and the second network may include a variety of network devices, including routers, bridges, servers, computing devices, storage devices, etc.

In some embodiments, the processor 504 may be disposed in communication with a memory 510 (e.g., RAM, ROM, etc. not shown in FIG. 5) via a storage interface 508. The storage interface 508 may connect to memory 510 including, without limitation, memory drives, removable disc drives, etc., employing connection protocols such as serial advanced technology attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 510 may store a collection of program or database components, including, without limitation, user interface 512, an operating system 514, web browser 515 etc. In some embodiments, computer system 500 may store user/application data, such as, the data, variables, records, etc., as described in this disclosure. Such databases may be implemented as fault-tolerant, relational, scalable, secure databases such as Oracle® or Sybase®.

The operating system 514 may facilitate resource management and operation of the computer system 500. Examples of operating systems include, without limitation, APPLE MACINTOSH® OS X, UNIX®, UNIX-like system distributions (E.G., BERKELEY SOFTWARE DISTRIBUTION™ (BSD), FREEBSD™, NETBSD™, OPENBSD™, etc.), LINUX DISTRIBUTIONS™ (E.G., RED HAT™, UBUNTU™, KUBUNTU™, etc.), IBM™ OS/2, MICROSOFT™ WINDOWS™ (XP™, VISTA™/7/8, 10 etc.), APPLE® IOS™ GOOGLER ANDROID™, BLACKBERRY® OS, or the like.

In some embodiments, the computer system 500 may implement the web browser 515 stored program component. The web browser 515 may be a hypertext viewing application, for example MICROSOFT® INTERNET EXPLORER™, GOOGLER CHROME™, MOZILLA® FIREFOX™, APPLE® SAFARI™, etc. Secure web browsing may be provided using Secure Hypertext Transport Protocol (HTTPS), Secure Sockets Layer (SSL), Transport Layer Security (TLS), etc. Web browsers 515 may utilize facilities such as AJAX™, DHTML™, ADOBE® FLASH™, JAVASCRIPT™, JAVA™, Application Programming Interfaces (APIs), etc. In some embodiments, the computer system 500 may implement a mail server (not shown in Figure) stored program component. The mail server may be an Internet mail server such as Microsoft Exchange, or the like. The mail server may utilize facilities such as ASP™, ACTIVEX™, ANSI™ C++/C#, MICROSOFT®, .NET™, CGI SCRIPTS™, JAVA™, JAVASCRIPT™, PERL™, PHP™, PYTHON™, WEBOBJECTS™, etc. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. In some embodiments, the computer system 500 may implement a mail client stored program component. The mail client (not shown in Figure) may be a mail viewing application, such as APPLE® MAIL™, MICROSOFT® ENTOURAGE™, MICROSOFT® OUTLOOK™, MOZILLA® THUNDERBIRD™, etc.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, non-volatile memory, hard drives, Compact Disc Read-Only Memory (CD ROMs), Digital Video Disc (DVDs), flash drives, disks, and any other known physical storage media.

The present disclosure relates to generating dynamic virtual representations for medical training. The present disclosure incorporates variance in physiology between different patient cases for generating the 3D virtual representations. This results in generation of unique patient scenarios for medical training of a user. The present disclosure generates various dynamic virtual representations corresponding to the 3D virtual representations by simulating haptic properties. This allows the user to receive real-time haptic feedback while undertaking the medical training. Hence, the present disclosure provides unique dynamic and interactive patient scenarios for medical training of the user. The present disclosure considers the skill level of a user when providing the dynamic virtual representation for medical training. Hence, the difficulty of training scenario is automatically adjusted according to the skill level of the user, thus improvising learning experience of the user.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise. The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIGS. 4A and 4B show certain events occurring in a certain order. In alternative embodiments, certain operations may be performed in a different order, modified, or removed. Moreover, steps may be added to the above-described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

### REFERRAL NUMERALS

| Referral Number | Description |
|---|---|
| 100 | Exemplary environment |
| 102 | One or more sources |
| 104 | Medical training device |
| 106 | Neural network model |
| 108 | Plurality of dynamic virtual representations |
| 110 | System |
| 112 | User |
| 114 | Haptic device |
| 116 | Database |
| 200 | Detailed diagram |
| 202 | I/O interface |
| 204 | Memory |
| 206 | Processor |
| 208 | Data |
| 210 | Modules |
| 212 | Communication data |
| 214 | Virtual representation data |
| 216 | Dynamic representation data |
| 218 | Other data |
| 220 | Communication module |
| 222 | Virtual representation module |
| 224 | Dynamic representation module |
| 226 | Other modules |
| 500 | Computer system |
| 502 | I/O interface |
| 504 | Processor |
| 506 | Network interface |
| 508 | Storage interface |
| 510 | Memory |
| 512 | User interface |
| 514 | Operating system |
| 516 | Web browser |
| 518 | Communication network |
| 520 | Input device |
| 522 | Output device |
| 524 | User |

We claim:

1. A method of generating dynamic virtual representations for medical training, the method comprising:
receiving, by a medical training device (104), a request for undertaking a medical training on a medical procedure and user skill information, from a user (112); and
providing, by the medical training device (104), a dynamic virtual representation from a plurality of dynamic virtual representations (108) corresponding to the medical procedure, based on the request and the user skill information, wherein the medical training device (104) generates the plurality of dynamic virtual representations (108) for each of a plurality of medical procedures using a neural network model (106), wherein generating the plurality of dynamic virtual representations (108) for each of the plurality of medical procedures comprises:
obtaining real-time patient data corresponding to a plurality of patients, the real-time patient data comprising imaging data and surgical data for each of the plurality of medical procedures, from one or more sources (102);
generating a plurality of three-dimensional (3D) virtual representations for each of the plurality of medical procedures, by mapping the corresponding imaging data and the surgical data using the neural network model (106); and
generating the plurality of dynamic virtual representations (108) for each of the plurality of medical procedures, by simulating one or more haptic properties corresponding to the plurality of 3D virtual representations, wherein the user (112) receives haptic feedback while undertaking the medical training based on the one or more simulated haptic properties.

2. The method as claimed in claim 1, wherein providing the dynamic virtual representation based on the user skill information comprising:
identifying a skill level associated with the user (112) based on the user skill information;
mapping the skill level of the user (112) with a risk level associated with each of the plurality of dynamic virtual representations (108) based on predefined mapping information; and
providing the dynamic virtual representation based on the mapping.

3. The method as claimed in claim 1, wherein generating the plurality of 3D virtual representations based on the mapping, comprising:
identifying a plurality of medical conditions associated with the plurality of patients, based on the imaging data, using the neural network model (106);
identifying an anatomy of each of the plurality of patients, tools associated with a surgery, a sequence of usage of the tools, for each of the plurality of medical procedures, based on the surgical data, using the neural network model (106); and
generating the plurality of 3D virtual representations, based on the identification.

4. The method as claimed in claim 3, wherein identifying the plurality of medical conditions, comprising:
reconstructing patient anatomy using the imaging data; and
identifying the plurality of medical conditions based on the reconstructed patient anatomy, using the neural network model (106).

5. The method as claimed in claim 1, wherein simulating the one or more haptic properties comprising:
identifying the one or more haptic properties of tools associated with the medical procedure and anatomy of the plurality of patients, based on the imaging data and the surgical data;
generating a force value for each of the one or more haptic properties corresponding to the tools and the anatomy; and
simulating the one or more haptic properties corresponding to the plurality of 3D virtual representations by associating the force value of respective haptic properties.

6. The method as claimed in claim 1, wherein the one or more haptic properties comprising at least one of, material surface properties and physical properties.

7. A medical training device (104) for generating dynamic virtual representations for medical training, the medical training device (104) comprises:
a processor; and
a memory, wherein the memory stores processor-executable instructions, which, on execution, causes the processor to:
receive a request for undertaking a medical training on a medical procedure and user skill information, from a user (112); and
provide a dynamic virtual representation from a plurality of dynamic virtual representations (108) corresponding to the medical procedure, based on the request and the user skill information, wherein the medical training device (104) generates the plurality of dynamic virtual representations (108) for each of a plurality of medical procedures using a neural network model (106), wherein generating the plurality of dynamic virtual representations (108) for each of the plurality of medical procedures comprises:
obtaining real-time patient data corresponding to a plurality of patients, the real-time patient data comprising imaging data and surgical data for each of the plurality of medical procedures, from one or more sources (102);
generating a plurality of three-dimensional (3D) virtual representations for each of the plurality of medical procedures, by mapping the corresponding imaging data and the surgical data using the neural network model (106); and
generating the plurality of dynamic virtual representations (108) for each of the plurality of medical procedures, by simulating one or more haptic properties corresponding to the plurality of 3D virtual representations, wherein the user (112) receives haptic feedback while undertaking the medical training based on the one or more simulated haptic properties.

8. The medical training device (104) as claimed in claim 7, wherein the processor provides the dynamic virtual representation based on the user skill information by:
identifying a skill level associated with the user (112) based on the user skill information;
mapping the skill level of the user (112) with a risk level associated with each of the plurality of dynamic virtual representations (108) based on predefined mapping information; and
providing the dynamic virtual representation based on the mapping.

9. The medical training device (104) as claimed in claim 7, wherein the processor generates the plurality of 3D virtual representations based on the mapping, by:
identifying a plurality of medical conditions associated with the plurality of patients, based on the imaging data, using the neural network model (106);
identifying an anatomy of each of the plurality of patients, tools associated with a surgery, a sequence of usage of the tools, for each of the plurality of medical procedures, based on the surgical data, using the neural network model (106); and
generating the plurality of 3D virtual representations, based on the identification.

10. The medical training device (104) as claimed in claim 9, wherein the processor identifies the plurality of medical conditions by:
reconstructing patient anatomy using the imaging data; and
identifying the plurality of medical conditions based on the reconstructed patient anatomy, using the neural network model (106).

11. The medical training device (104) as claimed in claim 7, wherein the processor is configured to simulate the one or more haptic properties by:
identifying the one or more haptic properties of tools associated with the medical procedure and anatomy of the plurality of patients, based on the imaging data and the surgical data;
generating a force value for each of the one or more haptic properties corresponding to the tools and the anatomy; and
simulating the one or more haptic properties corresponding to the plurality of 3D virtual representations by associating the force value of respective haptic properties.

12. The medical training device (104) as claimed in claim 7, wherein the one or more haptic properties comprising at least one of, material surface properties and physical properties.

13. A system (110) for generating dynamic virtual representations for medical training, the system (110) comprises:
a haptic device (114); and
a medical training device (104) as claimed in claims 7-12.
